(19) United States
(12) Patent Application Publication
(10) Pub. No.: US 2002/0176927 A1
(43) Pub. Date: Nov. 28, 2002

(54) Combinatorial synthesis of material systems

(76) Inventors: Toivo T. Kodas, Albuquerque, NM (US); Mark J. Hampden-Smith, Albuquerque, NM (US)

Correspondence Address: MARSH FISCHMANN & BREYFOGLE LLP, Suite 411, 3151 S. Vaughn Way, Aurora, CO, 80014, US

(21) Appl. No.: 09/821,848

(22) Filed: Mar. 29, 2001

(51) Int. Cl. B05D 1/36

(52) U.S. Cl. 427/8; 427/402; 427/407.1

(57) ABSTRACT

Methods for formulating material systems of varying chemistry and stoichiometry. The material systems include two or more components and can be analyzed to select the system having the best properties for a particular application. Specific examples of materials systems that can be fabricated and analyzed according to the present invention include layers for membrane electrode assemblies (MEA's) that are useful in the construction of fuel cells and similar devices.

### BACKGROUND OF THE INVENTION

1. Field of the Invention

The present invention relates to methods and apparatus for the rapid synthesis of a plurality of different material systems that include two or more components wherein one or more of the components vary in composition, morphology, concentration or other property within the material system. The material systems can be analyzed to select the system having the most desirable properties for a selected application. The present invention also relates to testing arrays (combinatorial libraries) of materials systems formed by such methods.

2. Description of Related Art

A great deal of time and effort is typically required to discover and optimize new chemical compounds and material systems for a selected product application. The primary hindrance to rapid development in these areas is that it is difficult to predict the physical and chemical properties of various compounds or material combinations, particularly for compounds or material combinations that have been produced using different processing conditions. For example, given the number of available chemical elements and possible combinations of elements, it is extremely difficult and time consuming to prepare and analyze the many different chemical compounds that can be formed. Likewise, many applications require a material system having two or more different compounds or material phases that interact to produce a product having a desired set of properties. An example of such a material system is a thick-film paste composition. It is similarly difficult to rapidly and economically prepare and analyze all of the possible material combinations in such a system.

A technique referred to as combinatorial synthesis has been developed in recent years as a means to synthesize many different chemical compounds in a relatively short time. The different compounds can then be analyzed for one or more material properties.

For example, U.S. Pat. No. 5,776,359 by Schultz et al. discloses a method and apparatus for the preparation of a substrate having an array of diverse compounds in predefined regions on the substrate. To form the array, a predetermined amount of a first component of a material is selectively deposited onto portions of a substrate and a predetermined amount of a second component is separately deposited onto the same substrate portions, wherein the amounts of the first and second component are different at different portions of the substrate. The components can be deposited by a thin-film technique such as CVD or sputtering, or by a solution-depositing device such as a micropipet or inkjet. The resulting substrate is reacted and can then be analyzed to determine which material has the most advantageous properties for a selected application.

U.S. Pat. No. 6,013,199 by McFarland et al. is directed to the fabrication of a plurality of phosphor materials using a combinatorial synthesis method similar to that disclosed in commonly assigned U.S. Pat. No. 5,776,359. A combinatorial array of chemically distinct compounds is synthesized on a silicon substrate using either an electron beam evaporation system or a sol-gel technique. In the electron beam technique, combinations of masks and shutters are used to control deposition of materials on to predefined regions of the substrate. In the sol-gel technique, sol-gel precursor solutions are deposited onto a substrate to form the array. The arrays are annealed to induce formation of the desired phases.

U.S. Pat. No. 6,045,671 by Wu et al. also discloses a combinatorial synthesis technique that utilizes thin-film deposition to form the array. A physical masking system is utilized to create arrays of resulting materials that differ slightly in composition, stoichiometry and/or thickness. It is disclosed that the process can be utilized to form covalent network solids, ionic solids and molecular solids.

Despite the foregoing, there exists a need for a method that enables the rapid production of a plurality of different material systems for analysis wherein the material systems include two or more compounds or phases, such as particles dispersed in a matrix or liquid solutions having multiple components. It would be desirable to rapidly fabricate and analyze a wide range of material systems such as thick film pastes, polymer thick film pastes, layered structures, ultra-low fire compositions and the like. The methodology of the prior art does not readily permit the fabrication and analysis of such material systems.

### SUMMARY OF THE INVENTION

According to one embodiment of the present invention, a method for the fabrication of a plurality of material systems is provided. The method includes the steps of continuously providing a material system composition comprising at least a first material system component and a second material system component, depositing the material system composition onto a substrate and analyzing at least one material property of the material system composition, wherein a component material property of at least one of the first material system component and second material system component is varied on a real-time basis such that the material system composition comprises a first material system composition at a first time and a second material system composition at a second time.

According to another embodiment of the present invention, a method for the fabrication of a plurality of material systems is provided. The method includes the steps of continuously providing a material system composition comprising at least a first material system component and a second material system component, depositing the material system composition and analyzing at least one material property of the material system composition, wherein the relative concentration of at least one of the first material system component and the second material system component is varied on a real-time basis such that the material system composition comprises a first material system composition at a first time and a second material system composition at a second time.

According to another embodiment of the present invention, a method for the deposition and analysis of a multi-layer structure is provided. The method includes the steps of depositing a first material on a substrate, depositing a second material over the first material to form a multi-layer structure and analyzing the multi-layer structure for at least one material property, wherein the composition of at least one of the first material and the second material is varied on a real-time basis such that the multi-layer structure comprises a first multi-layer composition at a first time and a second multi-layer composition at a second time.

According to yet another embodiment of the present invention, a method for the deposition and analysis of a multi-layer structure is provided. The method includes the steps of depositing a first material on a substrate, depositing a second material over the first material to form a multi-layer structure and analyzing the multi-layer structure for at least one material property, wherein the ratio of the first material to the second material is varied on a real-time basis such that the multi-layer structure comprises a first multi-layer composition at a first time and a second multi-layer composition at a second time.

These and other embodiments of the present invention will be apparent from the following description of the present invention.

### BRIEF DESCRIPTION OF THE DRAWINGS

FIG. 1 illustrates a flowsheet of a method for the fabrication and deposition of a plurality of material systems according to an embodiment of the present invention.

FIG. 2 illustrates a flowsheet of a method for the fabrication and deposition of a plurality of material systems according to an embodiment of the present invention.

FIG. 3 illustrates the variation in precursor concentration during fabrication of a plurality of material systems according to an embodiment of the present invention.

FIGS. 4a-4c illustrate the deposition of patterns of material systems according to various embodiments of the present invention.

FIG. 5 illustrates a cross-sectional view of a multi-layer structure that can be fabricated according to an embodiment of the present invention.

FIG. 6 illustrates a testing probe for the analysis of a plurality of material systems according to an embodiment of the present invention.

### DETAILED DESCRIPTION OF THE INVENTION

The present invention is directed to the fabrication of a plurality of material systems in a manner that permits the subsequent analysis of the material systems to identify those that have the most advantageous properties for a selected application. The material systems can have different components and/or different relative concentrations of components.

As used herein, the term material broadly refers to inorganic compounds, organic compounds or materials consisting essentially of a single component, such as substantially pure metals or semiconductors. The term chemical compound refers to an organic or inorganic material that includes two or more elements that are chemically combined. Examples include metal oxides, polymers, metal alloys and the like. The term material composite refers to a combination of two or more material phases within a particle. The material phases may be distinct chemical phases (e.g., two different chemical compounds) or may be two distinguishable crystalline phases of the same or similar material. Examples include polymorphs (two distinguishable crystalline phases of the same material) or metal-carbon composites for electrocatalyst applications that consist of a catalytically active metal and/or metal oxide dispersed on a carbon or metal oxide support. The term material system refers to a combination of two or more materials that provide a desirable set of properties for a selected application. As is discussed hereinbelow, examples of materials systems include particles embedded in a matrix of another material, layered structures and mixtures of two or more components in a flowable vehicle such as in a thick film paste or ultra-low fire composition.

The present invention is applicable to a wide range of materials systems. The materials systems can include flowable, liquid components as well as particulate components. The present invention is particularly applicable to the fabrication and testing of thick film pastes including conventional and polymer thick film (PTF) pastes, cermets, ultra-low fire (ULF) compositions, ink-jet compositions, ultra-violet curable compositions and the like.

One embodiment of the present invention is directed to the fabrication and analysis of a plurality of conventional thick-film paste compositions. Conventional thick-film paste compositions are typically deposited onto a ceramic substrate and heated to a high temperature to form electronic features such as conductor paths, resistors and other electronic features.

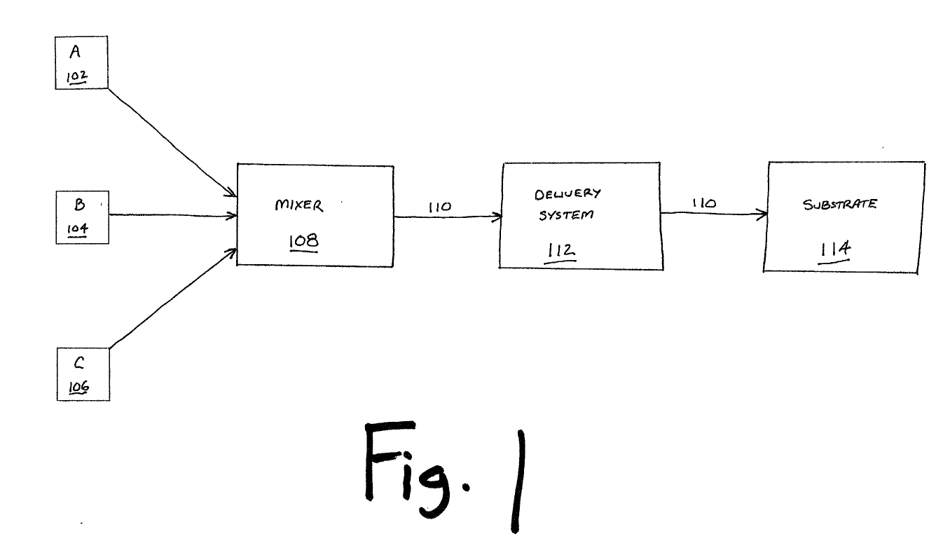

This embodiment of the present invention will be described with reference to FIG. 1, which illustrates a flowsheet for the fabrication and deposition of a plurality of intermixed material systems. The components of the paste 102, 104 and 106 are supplied to a mixer 108 in varying concentrations and/or ratios. The thick-film paste can include conductive, resistive or dielectric components as well as other thick-film paste components such as surfactants and organic vehicles. The mixer 108 can be an active or passive mixer so long as the components are well mixed. The mixed material system 110 is continuously supplied to a delivery system 112 such as a pen-dispense system described below and is deposited onto a substrate 114. After deposition, the paste, which has a gradient in material properties, can be heat-treated and tested for electrical and mechanical properties. A thick film paste (also referred to as a thick-film ink) includes a functional particulate phase, such as conductive powder, that is screen printed onto a substrate. In the thick-film process, a porous screen fabricated from stainless steel, polyester, nylon or similar inert material is stretched and attached to a rigid frame. A predetermined pattern is formed on the screen corresponding to the pattern to be printed. For example, a UV sensitive emulsion can be applied to the screen and exposed through a positive or negative image of the design pattern. The screen is then developed to remove portions of the emulsion in the pattern regions.

The screen is then affixed to a printing device and the thick film paste is deposited on top of the screen. The substrate to be printed is then positioned beneath the screen and the paste is forced through the screen and onto the substrate by a squeegee that traverses the screen. Thus, a pattern of traces and/or pads of the paste material is transferred to the substrate. The substrate with the paste applied in a predetermined pattern is then subjected to a drying and heating treatment to adhere the functional phase to the substrate. For increased line definition, the applied paste can be further treated, such as through a photolithographic process, to develop and remove unwanted material from the substrate.

Thick film pastes have a complex chemistry and generally include a particulate functional phase, a binder phase and an organic vehicle phase. The particle size, size distribution, surface chemistry and morphology of the particles can influence the rheology of the paste.

The binder phase is typically a mixture of inorganic binders such as metal oxide or glass frit powders. For example, PbO based glasses are commonly used as binders. The function of the binder phase is to control the sintering of the deposited paste and assist the adhesion of the functional phase to the substrate and/or assist in the sintering of the functional phase. Reactive compounds can also be included in the paste to promote adherence of the functional phase to the substrate.

Thick film pastes also include an organic vehicle phase that is a mixture of solvents, polymers, resins or other organics whose primary function is to provide the appropriate rheology (flow properties) to the paste. The liquid solvent assists in mixing of the components into a homogenous paste and substantially evaporates upon application of the paste to the substrate. Usually the solvent is a volatile liquid such as methanol, ethanol, terpineol, butyl carbitol, butyl carbitol acetate, aliphatic alcohols, esters, acetone and the like. The other organic vehicle components can include thickeners (sometimes referred to as organic binders), stabilizing agents, surfactants, wetting agents and the like. Thickeners provide sufficient viscosity to the paste and also act as a binding agent in the unfired state. Examples of thickeners include ethyl cellulose, polyvinyl acetate, resins such as acrylic resin, cellulose resin, polyester, polyamide and the like. The stabilizing agents reduce oxidation and degradation, stabilize the viscosity or buffer the pH of the paste. For example, triethanolamine is a common stabilizer. Wetting agents and surfactants are well known in the thick film paste art and can include triethanolamine and phosphate esters.

The different components of the thick film paste are mixed in the desired proportions in order to produce a substantially homogenous blend wherein the functional phase is well dispersed throughout the paste. The powder is often dispersed in the paste and then repeatedly passed through a roll-mill to mix the paste. The roll-mill can advantageously breakup soft agglomerates of powders in the paste. Typically, the thick film paste will include from about 5 to about 95 weight percent, such as from about 60 to 80 weight percent, of the functional phase.

Some applications of thick film pastes require higher tolerances than can be achieved using standard thick-film technology, as is described above. As a result, some thick film pastes have photo-imaging capability to enable the formation of lines and traces with decreased width and pitch. In this type of process, a photoactive thick film paste is applied to a substrate substantially as is described above. The paste can include, for example, a liquid vehicle such as polyvinyl alcohol, that is not cross-linked. The paste is then dried and exposed to ultraviolet light through a photomask to polymerize the exposed portions of paste and the paste is developed to remove unwanted portions of the paste. This technology permits higher density lines and pixels to be formed.

Conventional paste technology utilizes heating of a substrate to remove the vehicle from a paste and to fuse particles together or modify them in some other way. A laser can be used to locally heat the paste layer and scanned over the paste layer thereby forming a pattern. The laser heating is confined to the paste layer and drives out the paste vehicle and heats the powder in the paste without appreciably heating the substrate. This allows heating of particles, delivered using pastes, without damaging a glass or even polymeric substrate.

The thick-film paste could also be a polymer thick-film (PTF) paste. PTF pastes are commonly used in connection with low-temperature substrates that are used in the printed circuit board (PCB) industry, such as glass-epoxy (FR-4), polyester and polyimides. PTF pastes are a mixture of electrically active filler (e.g., dielectric particles such as a titanate or conductive particles such as silver or carbon) and an organic polymer, the filler being dispersed within the organic polymer. The PTF paste can also include other additives such as solvents. The PTF paste is deposited onto the substrate and cured by heating or exposure to ultraviolet light. PTF pastes are utilized in a wide variety of applications such as membrane touch switches, sensors, EMI shielding and the like for devices such as keyboards, telephony equipment and medical equipment. The present invention advantageously enables the rapid formulation of a wide range of PTF pastes that can be analyzed to select the paste with the most advantageous properties.

The present invention is also applicable to the formulation of ultra-low fire (ULF) compositions. ULF compositions react at a relatively low temperature to form a conductor on a substrate, thereby enabling the use of low-temperature substrates and reduced sintering temperatures. Specific examples of such ULF compositions that include a particulate phase are disclosed in U.S. Pat. No. 5,882,722 by Kydd et al. which is incorporated herein by reference in its entirety.

Such ULF compositions typically include a metal-organic decomposition (MOD) compound that decomposes at a low temperature, such as less than about 350° C. Examples of useful MOD compounds include carboxylic acid metal soaps such as silver neodecanoate. The composition can also include various solvents and carriers such as terpineol and other organics. The ULF composition can also include particulates such as silver particulates to enhance the properties of the conductive feature. The present invention advantageously enables the rapid formation of a range of ULF compositions that can be analyzed to select the composition with the most advantageous properties for a particular application

The present invention can also be utilized to formulate cermet compositions that include a mixture of ceramic and metal components in order to combine the strength and toughness of the metal with the heat and oxidation resistance of the ceramic. Cermets are typically made using powder metallurgy techniques and include a binding agent. The ceramic and metal components can be combined in various ratios to adjust the electrical and thermal properties of the cermet composition.

The material system could be a completely liquid solution that reacts with the substrate, such as an etchant composition including two or more components that etches the substrate. Examples of etchant compositions are those including β-diketones or carboxylic acid. In this embodiment, varying concentrations of the etchant components can be continuously provided to a mixing device and deposited onto a substrate. Depositing a varying composition of the etchant on a single substrate can provide a useful measure of the etching properties of the composition with respect to the substrate. Further, an unreacted solution of varying composition could be controllably deposited within a bed of particles and post-treated to form a matrix having a varying composition surrounding the particles.

The material system according to the present invention could also be an ink-jet composition that is formulated to have the desirable flow properties for deposition using an ink-jet device. Ink-jet compositions are complex mixtures that include a variety of components to achieve desired results for a given application. Among the components of an ink-jet composition are colorants (e.g. dyes), solvents, surfactants, humectants, penetrants, viscosity modifiers, dye solubilizers, dispersants, fixatives, pH buffers, chelation agents, biocides, hot-melt vehicles, plasticizers, UV-blockers, anticockle additives, nucleation aides, antikogation aides, free-radical inhibitors and antioxidants. The present invention advantageously enables the rapid formulation of different inkjet compositions that can be analyzed for both the deposition properties (e.g, how well the composition can be deposited using a selected ink-jet device) and the material properties after deposition. For example, the combination of dyes or the concentration of dyes can be varied to determine the best composition to produce a particular color. As is discussed above, the material system can include one or more particulate components. According to one embodiment of the present invention, the composition, morphology or other material property of the particulate can be varied to form material systems with varying properties. The description of this aspect of the present invention refers to a reaction to form reacted precursors (e.g., the particulates). Terms such as reaction, react, reactor and the like are used in a broad sense and can include processes wherein the starting material (i.e., the precursor) is merely heated or contacted with a gas or the like without a chemical reaction occurring. For example, the precursor may be heated or contacted with a gas to remove water or other solvents without chemically reacting the remaining components. As another example, metal powder may be supplied to a heated reactor to rapidly melt the powder without chemically reacting any of the components of the metal powder. These and similar processes are included within the scope of the present invention.

Further, the term reacted precursor refers to the material that exits the reactor portion of the apparatus that forms the particulates. The reacted precursor can be a completely reacted precursor in which case substantially no further treatment is needed to fabricate the final material. However, the reacted precursor can also be a partially reacted precursor wherein the reacted precursor is collected and is then further reacted to form the final material. Further, the precursor may be processed without the occurrence of any substantial reaction.

The present invention is directed to the fabrication of a plurality of different material systems that include two or more components and the components of the material system can include reacted precursors having varying composition or reacted precursors that have been formed under varying reactor conditions. This aspect of the present invention can be implemented using a number of different reactor systems. The reactor system requires a reactor capable of reacting the precursor on a continuous basis, such as by heating or contacting with a gas, and means for delivering the precursor to the reactor. In one embodiment, the reactor system includes means for varying the composition of the precursor on a real-time basis while the precursor is being delivered to the reactor. As used herein, real-time basis means that the variable, in this case precursor composition, is changed without any substantial interruptions in the operation of the reactor system. In another embodiment, the conditions under which the precursor is reacted such as reaction time, reaction temperature or carrier gas composition is varied on a real-time basis. It will be appreciated that the foregoing embodiments can be combined such that the reactor system provides variation of both the precursor composition and the reactor conditions on a real-time basis.

A preferred reactor system according to one embodiment of the present invention is a spray pyrolysis system. In a spray pyrolysis system, non-volatile precursors in a flowable medium are atomized to form droplets and the droplets are heated to form particulate reacted precursors. The term spray pyrolysis, as used herein, can also include spray conversion wherein the precursors to the final product are only partially converted or are converted to an intermediate product. Spray pyrolysis is advantageous in that powders with complex compositions can be produced, the powders are typically unagglomerated without milling, and the powders have a high purity and a homogenous composition. In accordance with the present invention the composition of the precursor, such as the ratio of different precursor components, can be varied on a real-time basis to continuously produce reacted precursor particles of varying composition.

An example of a spray pyrolysis system is illustrated in commonly owned U.S. Pat. No. 6,103,393, issued Aug. 15, 2000, which is incorporated herein by reference in its entirety. In a spray pyrolysis system, the liquid-containing precursor is continuously atomized to form an aerosol of fine droplets that is passed through a reactor where the liquid evaporates and the precursors are converted to a reacted precursor. Spray pyrolysis can utilize non-volatile precursors such as metal salts that have been dissolved in a solvent, such as water. Although the precursor is in flowable form to facilitate atomization of the precursor, particulate precursors can also be included provided that the particulates are small enough in size to be suspended and carried by the precursor droplets. Examples include particulate carbon and particulate metal oxides.

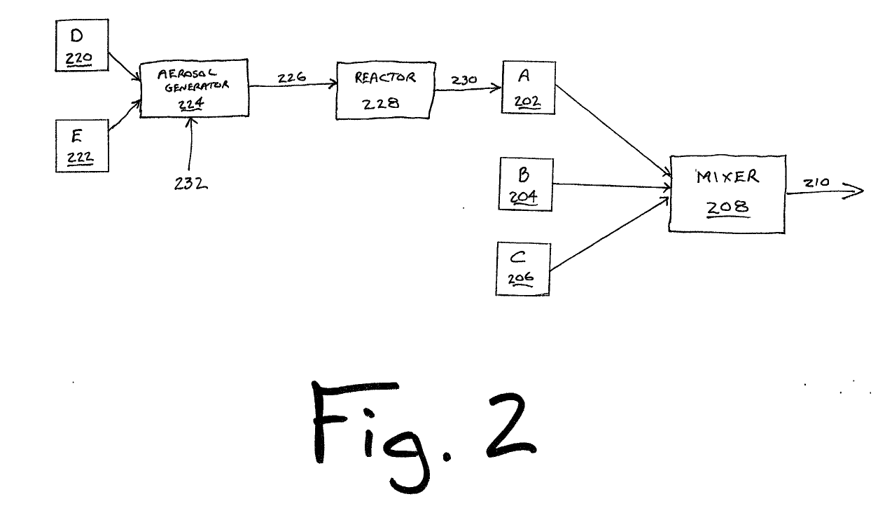

A process block diagram generally illustrating a spray pyrolysis reactor system incorporated into the method of the present invention is illustrated in FIG. 2. In the embodiment illustrated in FIG. 2, two different Precursors, D 220 and E 222, are utilized to form a two-component material, Precursor A 202. Precursor D 220 and Precursor E 222 are supplied to an aerosol generator 224 wherein the ratio of the precursors is varied on a real-time basis during the process. The precursor composition can be varied substantially continuously or can be varied in a step-wise manner. A carrier gas 232 is supplied to the aerosol generator 224 to move the generated precursor droplets 226 to a reactor 228 where the precursor droplets 226 are heated to form reacted precursors 230. The reacted precursor 230 then becomes Precursor A 202 that is combined with Precursor B 204 and Precursor C 206 in a mixer 208 to form a material system 210 that can be deposited and analyzed as is discussed with respect to FIG. 1 above.

The aerosol generator 224 used in such a spray pyrolysis system can be selected from a number of devices including single-fluid nozzles, two-fluid nozzles, ultrasonic nozzles and rotary atomizers. The preferred aerosol generator can be selected taking into consideration, for example, the desired particle size of the reacted precursor particles, the desired production rate and the precursor composition. Particularly preferred for many applications are ultrasonic transducers, also referred to as ultrasonic fountains. Precursor compositions having high levels of particulate precursors or a high viscosity may require a nozzle-based system to form the precursor droplets.

When the reaction variable is the precursor composition, fresh precursor is continuously supplied to the aerosol generator 224. Thus, in the case of an ultrasonic generator, the precursor is continuously flowed over the ultrasonic transducers. Precursor that is not generated into the aerosol can be discarded or recycled.

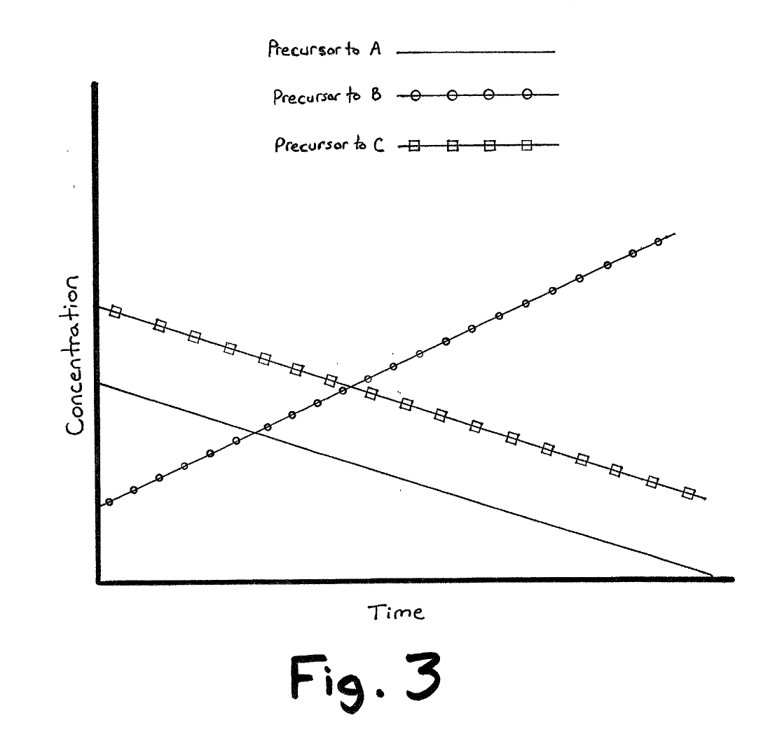

FIG. 3 illustrates the concentration of three components of a precursor composition over time as the process according to an embodiment of the present invention is carried out. The concentration of Precursor B is increased as the concentration of Precursors A and C is decreased. As a result, the reacted precursor exiting the reactor at the beginning of the process will have a composition that is high in A and C, such as a metal alloy including 34% A, 16% B and 50% C, whereas at the end of the process the composition will be high in B such as a metal alloy including 83% B and 17% C. Between the two endpoints will be a wide variety of alloys or inter-metallic compounds in the A-B-C system that can be analyzed to identify the material with the most advantageous properties for a selected application. The rate at which the concentration of a selected species in the precursor is changed can vary depending on a number of factors. Generally, the concentration of a selected species can vary from about 0.1 weight percent per minute to about 10 weight percent per minute. Although FIG. 3 illustrates a substantially continuous variation of the ratio of components in the precursor, it will be appreciated that the precursor composition can also be varied in a step-wise manner where there is a substantially instantaneous change in the concentration of one or more of the precursors.

For the fabrication of metals, metal oxides and other metal-containing compounds using a spray pyrolysis system, soluble salts of the metal are generally preferred as precursors. Whether the precursor reacts to form a metal or a metal compound such as a metal oxide depends primarily upon the other constituents of the precursor composition and the gas composition in which the reaction takes place. Oxidizing carrier gases such as air generally produce metal oxides whereas non-oxidizing carrier gases such as nitrogen generally lead to the production of metals. Also, for example, sulfur-containing precursor compositions such as those including thioacetic acid can be used to form metal sulfides.

The precursor composition for spray pyrolysis can include metal salts such as metal nitrates, chlorides, sulfates, hydroxides, halides, sulfates, phosphates, carbonates or carboxylates or beta-diketonates. For many applications, metal nitrates are preferred for their high solubility and ease of use. The precursor solution may be acidified to increase the solubility of the metal salt in the solution.

By way of example, one embodiment of the present invention is directed to the fabrication of multi-component material systems that include electrocatalyst materials. Such electrocatalysts can be composite electrocatalysts that include a catalytically active metal or metal oxide dispersed on a support.

One preferred catalytically active metal for electrocatalyst applications is platinum (Pt). Preferred precursors for platinum metal are H₂PtCl₆.xH₂O (chloroplatinic acid), H₂Pt(OH)₆ (hydroxoplatinic acid), platinum amine nitrates or diamine nitrates such as Pt(NH₃)₄(NO₃)₂ (tetramine platinum nitrate), Na₂Pt(OH)₆ (sodium hexahydroxyplatinum), K₂Pt(OH)₆ (potassium hexahydroxyplatinum), platinum nitrates, PtCl₄ (platinum tetrachloride), Na₂PtCl₄, and the like. Chloroplatinic acid is soluble in water and the solutions advantageously maintain a low viscosity. Hydroxoplatinic acid is advantageous since it converts to platinum metal at relatively low reaction temperatures.

Another useful metal is palladium (Pd) and palladium precursors can include inorganic palladium salts such as Pd(NO₃)₂ (palladium nitrate), PdCl₂ (palladium (II) chloride), H₂PdCl₄ or Na₂PdCl₄, complex palladium salts such as Pd(NH₃)₄Cl₂ or Pd(NH₃)₂(OH)₂, palladium carboxylates and the like.

Another useful metal is ruthenium (Ru) and ruthenium precursors include Ru β-diketonates, Ru(NO)(NO₃)₃ (ruthenium nitrosyl nitrate), K₃RuO₄ (potassium perruthenate), Na₃RuO₄ (sodium perruthenate), (NH₄)₃Ru₂O₇, NH₄Ru₂O₇, Ru₃(CO)₁₂ and RuCl₃ (ruthenium chloride).

Silver precursors include Ag₂CO₃ (silver carbonate), AgNO₃ (silver nitrate), AgOOCCH₃ (silver acetate), silver amine nitrate complexes, silver carboxylates and silver oxalate. Gold precursors include AuCl₃ (gold chloride) and (NH₄)AuCl₄ (ammonium tetrachloroaurate). Nickel precursors include Ni(OOCCH₃)₂ (nickel acetate), NiCl₂ (nickel chloride), Ni(CHO₂)₂ (nickel formate) and Ni(NO₃)₂ (nickel nitrate). Copper precursors include copper carboxylates, Cu(OOCH₃)₂ (copper acetate), CuCl₂ (copper chloride), Cu(NO₃)₂ (copper nitrate), and Cu(ClO₄)₂ (copper perchlorate). Rhodium precursors can include RhCl₃.xH₂O (rhodium chloride hydrate), (NH₄)₃RhCl₆.xH₂O (ammonium hexachlororhodium hydrate) and Rh(NO₃)₃ (rhodium nitrate).

Titanium precursors include TiCl₃ (titanium (III) chloride), TiCl₄ (titanium (IV) chloride), and TiCl₄(NH₃)₂ (tetrachlorodianimo titanium). Vanadium precursors include VCl₃ (vanadium (III) chloride), VCl₄ (vanadium (IV) chloride), VF₄ (vanadium fluoride) and NH₄VO₃ (ammonium vanadium oxide). Manganese precursors include MN(OOCCH₃)₂.xH₂O (manganese (II) acetate hydrate), Mn(OOCCH₃)₂.xH₂O (manganese (III) acetate hydrate), MnCl₂.xH₂O (manganese chloride hydrate), Mn(NO₃)₂ (manganese nitrate) and KmnO₄ (potassium permangate). Iron precursors include Fe(OOCCH₃)₂ (iron acetate), FeCl₂.xH₂O (iron chloride hydrate), FeCl₃.xH₂O (iron chloride hydrate), Fe(NO₃)₃.xH₂O (iron nitrate hydrate), Fe(ClO₄)₂.xH₂O (iron (II) perchlorate hydrate) and Fe(ClO₄)₃.xH₂O (iron (III) perchlorate hydrate).

Cobalt precursors include Co(OOCCH₃)₂.xH₂O (cobalt acetate hydrate), CoCl₂.xH₂O (cobalt chloride hydrate) and Co(NO₃).xH₂O (cobalt nitrate hydrate). Tungsten precursors include WOCl₄ (tungsten oxychloride) and (NH₄)₁₀W₁₂O₄₁ (ammonium tungsten oxide). Zinc precursors include Zn(OOCCH₃)₂.xH₂O (zinc acetate), ZnCl₂ (zinc chloride), Zn(OOCH)₂ (zinc formate), and Zn(NO₃)₂.xH₂O (zinc nitrate hydrate). Zirconium precursors include ZrCl₄ (zirconium chloride), ZrH₂ (zirconium hydride) and ZrO(NO₃)₂.xH₂O (zirconium dinitrate oxide). Niobium precursors include NbCl₅ (niobium chloride) and NbH (niobium hydride). Molybdenum precursors include molybdenum chloride, Mo(CO)₆ (molybdenum hexacarbonyl), (NH₄)Mo₇O₂₄.xH₂O (ammonium paramolybdate), (NH₄)₂Mo₂O₇ (ammonium molybdate) and Mo[(OCOCH₃)₂]₂ (molybdenum acetate dimer). A preferred tin precursor is SnCl₄.xH₂O.

The foregoing precursors can be combined in various ratios to form metal alloys having a range of alloy compositions. For example, platinum can be alloyed with ruthenium, tin, molybdenum, chromium or copper. Additives to the foregoing precursors to reduce the decomposition temperature of the precursor can also be utilized. For example, ethanol or methanol added to a platinum precursor can reduce the decomposition temperature.

The present invention is also applicable to the fabrication of composite particles, such as composite electrocatalyst particles. The composite electrocatalyst particles include a conductive support phase, such as carbon. In this embodiment, the precursor solution also includes at least one carbon precursor. The carbon precursor can be an organic precursor such as carboxylic acid, benzoic acid, polycarboxylic acids such as terephthalic, isophthalic, trimesic and trimellitic acids, or polynuclear carboxylic acids such as napthoic acid, or polynuclear polycarboxylic acids. Organic precursors can react by a mechanism such as:

aM(NO₃)ₙ+b(CₓH_{y}O_{z})ₘ→MₐC_{b}

The use of a liquid organic carbon precursor typically results in amorphous carbon, which is not desirable for many applications. Therefore, the carbon support precursor is preferably a dispersion of suspended carbon particles. The carbon particles can be suspended in water with additives such as surfactants to stabilize the suspension if necessary.

The carbon particulates are small enough to be dispersed and suspended in the droplets generated from the liquid precursor. Therefore, the particulates preferably have an average size of up to about 100 nanometers, such as from about 10 to about 60 nanometers when the aerosol is being generated using ultrasonics. Spray nozzles can accommodate larger particulates such as those having a size of up to about 30 μm. Particulate materials can exist in different crystallographic forms, for example carbon can be crystalline (graphitic), amorphous or a combination of different carbon types. According to one embodiment of the present invention, the type of carbon support can be varied.

After atomization of the precursor composition, liquid is removed from the droplets by evaporation in the reactor 228. A particularly preferred reactor for spray pyrolysis is a hot-wall reactor such as a tubular furnace. A hot-wall reactor transfers heat into the particle by maintaining a fixed wall temperature within the reactor zone. The carrier gas absorbs heat from the walls of the reactor until it reaches thermal equilibrium with the reactor walls. The advantages of a hot-wall reactor include the ability to control the time/temperature history of the precursor droplet/particle with greater precision over longer time intervals and the ability to achieve high processing temperatures. A hot-wall reactor is particularly useful when the reaction temperature or time is a selected process variable.

A spray pyrolysis system also enables the rapid formation of the reacted precursor. The typical reaction time in such a reactor system is less than about 10 seconds, such as from about 0.5 to about 5 seconds. Rapid formation of materials and accurate control over the time/temperature history enable precise control over the composition of the reacted precursors.

Other mechanisms such as gas-to-particle conversion (GPC) can also be used to form the reacted precursors in accordance with the present invention. Using GPC, particles are formed by nucleation and growth of low vapor pressure species. Thus, a supersaturated vapor of metal atoms is formed that condenses from the gas phase as the reactants cool. Additional precursor can decompose on the metal surface, further increasing the size of the particles. GPC utilizes either gas-phase reactants directly or utilizes volatile precursors that are dissolved in a precursor solution. In the latter case, the droplets are formed in the same way as described for spray pyrolysis, however, the solvent and the precursors completely evaporate into the gas phase before they react. GPC can also be combined with spray pyrolysis in a hybrid process, such as where a solution containing a fuel that burns around the particles is used resulting in volatilization of the solids in the particles followed by gas to particle conversion.

The β-diketonate derivatives of most electropositive elements are volatile and after evaporation into the gas phase thermally decompose to form the corresponding metal oxide. For example, Mg, In, Sn and Ce β-diketonates are all volatile compounds that are suitable for GPC. Other examples of compounds that can be used as GPC liquid precursors include metal halides, amides, alkoxides, metal alkyls or carboxylates. The resulting particulate reacted precursors generally have an average particle size that is smaller than the particles produced by spray pyrolysis and the average particle size is typically from about 1 nanometer to about 500 nanometers.

The present invention is particularly useful for investigating various precursors and reaction conditions used in GPC formation of particles since it is very difficult to predict the composition and morphology of particles produced using such methods due to the non-linear reaction characteristics of the nucleation and growth and the diffusional mechanisms.

According to one embodiment of the present invention, supported electrocatalysts such as platinum on carbon can be formed by GPC. For example, a platinum precursor such as platinum β-diketonate or Pt(PF₃)₄ (platinum tetrakis trifluorophosphine) can be heated to volatilize the platinum which is dispersed in a gas phase with carbon particles. The platinum precursor decomposes to form platinum atoms in the gas phase which will then deposit on the carbon particles as the reactants cool forming composite particles wherein the metal is dispersed on the support. The electrocatalyst can then be deposited, for example, with a polymer to observe the electrocatalytic activity of a range of electrocatalyst in a polymer composition.

In addition to the foregoing, virtually any reactor system that permits real-time control over the precursor composition and/or real-time control over the precursor reaction conditions can be utilized. For example, a thermal plasma reactor can be utilized. In a thermal plasma reactor, a high temperature plasma is used to provide the energy required for particle formation and growth. A plasma is a system with a high energy content in which a significant fraction of the species are ionized and are conductors of electricity. Precursors can be introduced to the plasma as powders or as gaseous reactants. Plasma reactors typically completely vaporize and dissociate the reactants into their atomic form. Gaseous species can nucleate to form particles as the gas is cooled upon exiting the plasma. Plasma reactors can be particularly advantageous for the formation of materials having a high melting point, such as non-oxide ceramics. Plasma reactors can also be used to form composites such as platinum metal on carbon or platinum metal on a metal oxide.

Other reactor systems that can be used include those that form molten droplets of a material. Examples include plasma spray systems, flame spray systems and systems utilizing molten-metal atomization and spraying. In these reactor systems, particles of a solid precursor are melted and deposited, after which they solidify and form a film or coating. A wide variety of metal alloys and ceramics can be fabricated using such systems. As with the foregoing reactor systems, the composition of the precursor feed (e.g., the dry powder) can be varied to form a material layer having a compositional gradient or the conditions of the reactor (e.g., the temperature) can be changed to modify the properties of the layer.

It will be appreciated that a reactor system can also be used wherein no substantial reaction occurs in the reactor. For example, the hot-wall reactor may be heated to a temperature that merely removes solvent from dispersed droplets without substantially reacting the precursor components. Further, the reactor system does not necessarily supply heat to the precursor composition to form reacted precursor particles. The system could, for example, merely supply sufficient hydrogen to reduce a metal carboxylate precursor at ambient temperature. The reactor could also supply sufficient light energy to a photosensitive monomer precursor to initiate polymerization and form polymer particles. For example, monomers can be dispersed in a liquid carrier (e.g., water) and subsequently polymerized. Polymerization is initiated within the droplet when the monomer reacts under light or heat to form a polymer particulate. Free radical initiators can also be placed in solution to initiate the reaction.

In addition, the dispersed droplets can be formed and can then be directed toward a heated substrate, which supplies sufficient heat two reacted precursors on the substrate surface. Thus, the precursor droplets form a coating on the substrate surface.

The reacted precursors can also be formed by nucleation and precipitation from a liquid in a micro-reactor over a controlled time period. In this embodiment, various precursors in a flowable liquid form are mixed and delivered to a reactor that is adapted to contain the precursors for a time sufficient to permit the reaction. The reacted precursors are then continuously removed from the micro-reactor. For example, the micro-reactor could include an elongate narrow reaction chamber wherein the precursors react as the liquid flows through the reaction chamber. The micro-reactor could include heating means for gently heating the liquid, a reducing agent could be included with the liquid wherein the reducing agent reacts in the micro-reactor and/or a reaction gas could be flowed through the reactor and in contact with the liquid as the reaction occurs. The reacted precursors can be easily separated from any remaining liquid and supplied as a component of a material system.

Depending on the reactor system and the reactor conditions, the reacted precursor particles can have a wide range of sizes, from 1 nm to 100 μm or higher. For example, particles having a size of from about 5 nm to about 1 μm can be formed by GPC and particles having an average size of from about 0.5 μm to about 10 μm under can be formed by spray pyrolysis. The preferred size of the reacted precursors will depend upon the application of the reacted precursors.

Where the reactor temperature is varied during synthesis of particles, the reactor temperature is changed and a rate that is slow enough to produce useful quantities of particulates at different temperatures but rapid enough to provide meaningful data. For example, the reaction temperature and a rate of from about 0.5° C./min to about 10° C./min, such as from about 1° C./min to about 5° C./min.

It is an advantage of the present invention that the reacted precursor can be formed while in a dispersed state. That is, the reacted precursor need not be in direct contact with a support surface when it is formed. Further, no significant diffusional mechanisms are involved in the formation of the particles since the precursors are intimately mixed during formation of the reacted precursor particles.

The materials system can be delivered to a substrate for analysis using a variety if techniques. For example, the materials system, after sufficient mixing, can be delivered to the substrate using a nozzle-based system. The movement of the nozzle, the substrate or both should be controlled. For example, the nozzle can be provided with a control mechanism to control the movement of the nozzle relative to the substrate. The nozzle can be controlled to deliver the material system to the substrate in a staggered manner such that the substrate consists of an array of individual regions of material. Alternatively, the nozzle can be moved continuously in relation to the substrate to form a linear feature wherein the composition or other property of the material system varies throughout the linear feature.

In one embodiment, the particles are collected on a long, continuously moving substrate that passes under a stationary nozzle. Preferably, the substrate is flexible to enable the substrate to be rolled into a compact form. Alternatively, the substrate could be a circular substrate that rotates in relation to the nozzle. In either embodiment, the substrate is preferably a filter material that permits passage of the carrier gas through the substrate while collecting the particles on the substrate surface. Examples of such filters include Teflon membrane filters, Teflon fiber filters or glass fiber filters.

The materials system can also be deposited onto a substrate using a direct-write tool. As used herein, a direct-write tool is a device that deposits a liquid or liquid suspension onto a surface by ejecting the composition through an orifice toward the surface without contacting the surface. The direct-write tool is preferably controllable over an X-Y grid. One preferred direct-write tool for low viscosity material systems, as is discussed above, is an ink-jet device. Other examples of direct-write tools include nozzle systems such as automated syringes, for example the MICROPEN tool, available from Ohmcraft, Inc., Honeoye Falls, N.Y.

Ink-jet devices operate by generating droplets of ink and directing the droplets toward a surface. The position of the ink-jet head is carefully controlled and can be highly automated so that discrete patterns of the ink can be applied to the surface. Ink-jet printers are capable of printing at a rate of 1000 drops per second or higher and can print linear features with good resolution at a rate of 10 centimeters per second or more. Each drop generated by the ink-jet head includes approximately 100 picoliters of the liquid which is delivered to the surface. For these and other reasons, ink-jet devices are a highly desirable means for depositing low viscosity materials onto a substrate.

Typically, an ink-jet device includes an ink-jet head with one or more orifices having a diameter of less than about 100 μm, such as from about 50 μm to 75 μm. Ink in the form of droplets is directed through the orifice toward the surface being printed. Ink-jet printers typically utilize a piezoelectric driven system to generate droplets, although other variations are also used. Ink-jet devices are described in more detail in, for example, U.S. Pat. No. 4,627,875 by Kobayashi et al. and U.S. Pat. No. 5,329,293 by Liker, each of which is incorporated herein by reference in their entirety.

The relative speed of the substrate to the deposition nozzle or ink jet head is well-controlled to ensure that a sufficient quantity of material is collected to enable the analysis and selection of a preferred region on the substrate. For example, the relative speed of the substrate can be from about 0.5 cm/min to 10 cm/min, such as from about 1 cm/min to about 5 cm/min.

The substrate can be virtually any material that is amenable to the deposition of the materials system onto the substrate surface and subsequent treatment, if any. Examples of acceptable substrate materials include metals, polymers, ceramics and glasses. The substrate can also include depressions or wells wherein the different materials systems are deposited within the depressions to prevent inadvertent spreading to an adjacent area.

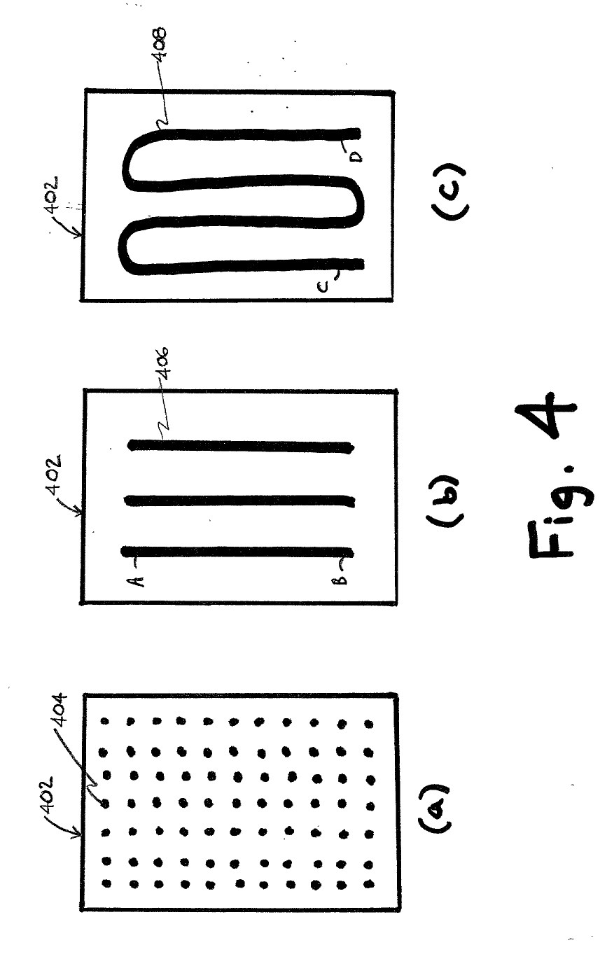

Different patterns for depositing the material systems on a substrate in accordance with the present invention are illustrated in FIGS. 4(a)-4(c). In FIG. 4(a), the material systems 404 are collected on a substrate 402 in a staggered manner such that the material systems 404 are deposited in small individual regions of the substrate 402. The substrate 402 can include, for example, a plurality of small wells or depressions in the surface of the substrate 402 to facilitate deposition of the material systems 404 into the pre-defined regions.

The present invention advantageously enables the formation of continuously varying linear features (e.g., test strips) that cannot easily be formed utilizing combinatorial methods of the prior art. In the embodiment illustrated in FIG. 4(b), the material systems are deposited in the form of individual test strips 406 on the substrate 402. Thus, the composition of the material systems at portion A is different then the composition of the material systems at portion B. The test strips can be deposited onto a flat substrate or can be deposited into trenches or similar depressed features that are formed in the substrate to prevent migration of material in a direction perpendicular to the test strip.

In one embodiment, the substrate can include trenches or wells to collect the particles and a substrate can subsequently be placed over the deposited particles to seal them in the trench or well. The particles (e.g., reformer catalyst particles) can then be analyzed by passing a gas composition (e.g., methanol) through the particles and measuring the off-gas composition with a chromatograph to determine the catalytic activity of the particles.

FIG. 4(c) illustrates an embodiment similar to that in FIG. 4(b), however, the test strip 408 is substantially continuous and is patterned across the substrate 402 to make effective use of the surface area available on the substrate 402. The composition or other material property of the material systems at portion C of the test strip 408 is different than the composition of the material systems at portion D.

The material systems that can be fabricated and analyzed in accordance with the present invention are not necessarily mixed systems such as thick film pastes. In accordance with one embodiment of the present invention, multiple layers can be deposited in contact with one another to form a material system that is a multi-layer structure that can then be analyzed for a particular property. In this embodiment, a first layer is deposited in the form of a test strip (e.g., FIG. 4(b) or 4(c)) and a second layer of a different material is deposited in contact with the first layer. The composition of one or both of the layers can be independently varied and additional layers can be added to the structure. For example, electrocatalyst compositions and polymers can be deposited in layers onto a substrate consisting of a polymer membrane to analyze different sections of the linear feature for their usefulness in a membrane electrode assembly (MEA), such as those utilized in a fuel cell. In addition, other properties of the layers such as the thickness of one or more layers can be systematically varied to ascertain the optimum thickness for a selected application. The layer thickness, for example, could be varied by altering the deposition rate of the deposition device for a selected layer.

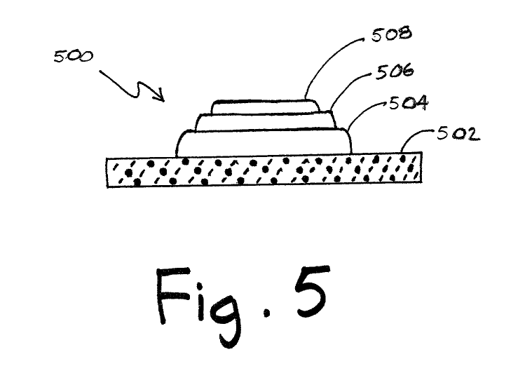

FIG. 5 illustrates a cross-section of such a multi-layer structure 500, specifically a layer that simulates a membrane electrode assembly for a fuel cell. The multi-layer structure 500 is deposited onto a polymer substrate 502. The first layer 504 can be, for example, an electrocatalyst composition such as a metal-carbon composite consisting of platinum metal dispersed on a carbon support. The second layer 506 can be, for example, a conductive ionomer such as a hydrophilic fluorocarbon polymer. The third layer 508 can be, for example, a hydrophobic material such as a hydrophobic fluorocarbon polymer. The multi-layer structure 500 can be probed along its length to determine which portion has the most advantageous properties for the selected application. It will be appreciated that one or more of the layers 504, 506 and 508 can be varied along the length of the deposited multi-layer structure as may be desirable for a selected application.

Other layered structures can be fabricated and analyzed in accordance with the present invention. In one embodiment, a layered structure that simulates a battery electrode can be fabricated and tested for electrocatalytic properties. For example, a cathode structure can be fabricated that includes a conductive layer of carbon particles and an electrocatalyst layer including electrocatalyst particles. Either or both of the carbon layer and electrocatalyst layer can include a fluorocarbon polymer carrier in which the particles are dispersed. Further, layers having various combinations of electrocatalyst and carbon can be deposited to find the most advantageous ratio or concentration of particles in a single layer for a selected application. The layers can advantageously be deposited on a gas-diffusion layer (e.g., carbon cloth) with a current collector to accurately mimic the structure of a cathode. By changing the layer properties, the material system having the best electrocatalytic properties can be selected.

Another particular example is the simulation of a supercapacitor device. Supercapacitors include multiple layers, such as alternating layers of insulating material, conductive material, ruthenium oxides (RuOₓ) and electrolytes to provide short, high-power bursts of energy. Supercapacitors can be used in conjunction with a battery to provide a wide range of power delivery capabilities. The performance of a supercapacitor under a given set of conditions is a function of the composition of the individual layers and the thickness of the layers. Finding the proper combination of parameters for a selected application is time consuming. The methodology of the present invention advantageously enables a plurality of structures to be constructed and analyzed in a relatively fast and economical manner.

The substrate onto which the reacted precursor is deposited for analysis may be an integral part of the material system that is to be analyzed. For example, in some applications it is desirable to deposit particles within a UV-curable polymer matrix. More particularly, dental glasses of varying composition or that have been reacted under different conditions can be deposited onto an uncured resin to determine which dental glass has an index of refraction that most closely matches the index of refraction of the resin. Further, the dental glass particles can be deposited into wells or trenches on a substrate and the resin can be filled into the wells or trenches after deposition of the glass particles. In addition to the index of refraction, the hardness and wear resistance of the dental glass/resin matrix can also be analyzed after the materials are cured.

The dental glass particles can also be treated with a silanating agent to promote adhesion to the resin. For example, the dental glass particles can be deposited into a trench formed in a substrate. Thereafter, a silanating agent can be deposited on the glass particles and the resin can then be deposited onto the particles. The resulting structure will be a continuously varying matrix of dental glass disposed in a resin that accurately simulates a dental composite material system.

After deposition of the material systems, the material systems can be reacted such as by heating the substrate to react the system components. Other means for further reacting the material systems include exposing the system to a forming gas or polymerizing a deposited organic compound. In addition, it may be desirable to heat the material systems at a sufficient temperature and for a sufficient amount of time to sinter or fuse the particles into solidified form.

As is discussed above, the material system of the present invention can include a variety of materials including single component materials such as non-alloyed metals, chemical compounds and material systems.

For example, the method of the present invention can be used to fabricate material systems that include single component, non-alloyed metal particles. In this embodiment, the reaction parameters utilized to fabricate the single component metal powders can be varied in order to change one or more material properties of the metal. For example, increasing or decreasing the reaction temperature and/or reaction time can affect the crystallinity and/or morphology of the particles. These intrinsic properties significantly influence the extrinsic properties such as electrical conductance and oxidation resistance.

The present invention can be utilized to investigate various carbon forms such as carbon nanotubes, fullerene structures and the like. Such structures can be formed from carbon precursors by GPC processes, particularly those utilizing a plasma arc for heating wherein carbon and a metal are vaporized and cooled to form unique structures. Other components can be added to form composite structures including the carbon structure, such as carbon nanotubes with a metal disposed in the structure. The present invention advantageously enables the rapid production of carbon structures under varied conditions such that the proper conditions for fabricating a desired structure can be identified.

The present invention is also useful for the synthesis and analysis of material systems that include metal alloys or intermetallics that combine two or more metals. For example, metal alloys are often synthesized to enhance one or more of the properties of the metal. The synthesis and analysis of such metals in the form of a thin film or a bulk material yields little useful information about the metal as it is used in a device, namely in the form of a particulate.

For example, it is often desirable to alloy platinum metal with additional elements such as ruthenium to alleviate this susceptibility to carbon monoxide poisoning in catalytic devices such as fuel cells. However, the optimum alloying level of ruthenium or other alloying elements in the platinum may be different for different applications. The present invention provides a means for rapidly synthesizing and analyzing metal alloys of varying composition.

Further, the present invention is applicable to a wide range of inorganic chemical compounds. For example, metal oxides, metal sulfides, metal carbides, metal nitrides, metal borides, metal tellurides and other inorganic compounds can be synthesized by varying the ratio of components in the precursor composition or by varying the reaction time, temperature or gas composition. Particularly preferred examples include inorganic compounds that are useful as phosphors and pigments.

The present invention is also applicable to material systems that include phosphor compounds in particulate form. The properties of phosphor compounds when analyzed in the form of a thin film or bulk material do not accurately reflect the performance of the phosphor compound when it is applied in the form of a powder, such as in a display device.

Typically, phosphors include a host materials (e.g., a metal oxide) that is doped with an activator ion, typically in an amount of from about 0.02 to about 20 atomic percent. According to one embodiment of the present invention, the amount of the activator ion can advantageously be varied in the precursor solution to synthesize particulate compounds having various amounts of activator ion. These compounds can then be tested under different activation energies to determine which phosphor compound has the optimum level of activator ion for a selected application. Further, different combinations of activator ions can be synthesized and tested in a similar fashion.

Phosphor compounds can be categorized by the excitation mechanism under which the phosphor compound is utilized. Electroluminescent phosphors are stimulated by an electrical source, photoluminescent phosphors are stimulated by a light source, energized electrons stimulate cathodoluminescent phosphors and x-ray phosphors are stimulated by an x-ray source.

Examples of electroluminescent phosphors that can be synthesized according to the present invention include sulfides, gallates and thiogallates, such as: ZnS doped with Au, Al, Cu, Ag, Cl or Mn; M¹S wherein M¹ is selected from the group consisting of Ba, Sr and Ca and wherein the particles are doped with Eu or Ce; M²Ga₂S₄ wherein M² is selected from the group consisting of Ca and Sr and wherein the dopant is Eu or Ce; ZnGa₂O₄ doped with Mn or Cr; M³Ga₂O₄ wherein M³ is selected from the group consisting of Ca and Sr and the dopant is selected from the group consisting of Ce and Eu (e.g. SrGaₓO_{y}:Eu); Y₂O₃ doped with a rare earth metal; Ga₂O₃ doped with Dy or Eu; CaGaₓO_{y}, such as Ca₃Ga₂O₆:Eu or Ce; Zn₂GeO₄:Mn; and Zn₂(Ge,Si)O₄:Mn.

Examples of cathodoluminescent phosphors that can be synthesized according to the present invention include: Y₂O₃:Eu; Y₂O₂S doped with Eu and/or Tb; ZnS doped with Au, Al, Cu, Ag or Cl; SrGa₂S₄ doped with Eu or Ce; Y₅(Ga,Al)₅O₁₂ doped with Tb or Cr; Zn₂SiO₄:Mn and Y₂SiO₅ doped with Tb or Ce.

Examples of photoluminescent phosphors that can be synthesized according to the present invention include: barium magnesium aluminate (e.g., BaMgAl₁₀O₁₇:Eu or Mn); zinc silicate (e.g. Zn₂SiO₄:Mn); yttria (e.g., Y₂O₃:Eu or Tb); yttrium gadolinium borate (e.g., (Y,Gd)BO₃:Eu) and barium aluminate (e.g., BaAlₓO_{y}:Mn).

Examples of x-ray phosphors that can be synthesized according to the present invention include: gadolinium-containing phosphors such as yttrium gadolinium borate (e.g., (Y,Gd)BO₃:Eu or Tb), gadolinium oxysulfide (e.g Gd₂O₂S:Tb), and yttrium gadolinium silicate (e.g., (Y,Gd)₂SiO₅:Tb or (Y,Gd)₂SiO₅:Tb, Ce).

The present invention is also applicable to the synthesis and analysis of material systems that include pigment particles. It is also advantageous to measure the properties of pigments in the particulate form rather than in a thin film or bulk form since a majority of applications of pigments utilize pigment particles and the size of the pigment particles significantly influences the optical properties. The pigment particles can advantageously be deposited into a carrier material to form a material system that more accurately simulates the optical properties of the particles in an actual application.

Inorganic pigments include many different compounds that are known in the art of pigments. Typically, inorganic pigments are composed of substantially water insoluble particles of transition metal oxides, e.g., oxides of the elements in Groups IIIA, IVA, VA, VIA, VIIA, VIIIA, IB and IIB of the Periodic Table. Common inorganic pigments include natural and synthetic iron oxide compounds such as Fe₂O₃ (red), Fe₃O₄ (black), (Fe,Cr)₂O₃ (brown), ZnFe₂O₄ (tan) and FeOOH (yellow). Chrome-based pigments are also common such as lead chromate salts, Cr₂O₃ (green), zinc chromate (yellow) and strontium chromate. Other complex inorganic pigments include nickel titanate, chrome titanate, manganese titanate and cobalt chromite. Cadmium pigments based on cadmium sulfide blended with other sulfides or cadmium compounds are also known. Other sulfide pigments are based on cerium sulfide modified with other rare earths. Cobalt compounds, such as cobalt aluminum oxide (CoAl₂O₄), are commonly used for blue. Rutile (TiO₂) is the most common white pigment and is commonly used in paper, plastics, printing inks, ceramics and building materials. TiO₂ with other elements such as Sb,Ni and Cr can provide different colors. Other white pigments include zinc oxide (ZnO), lead carbonate (PbCO₃), zinc sulfide (ZnS) and antimony trioxide (Sb₂O₃). Metal nitrides can also be used as pigments. Some pigments also include a dispersion of one or more metallic phases to enhance the color characteristics of the pigments. The foregoing list of inorganic pigment compounds is for the purpose of providing common examples and the present invention is not limited to the synthesis and analysis of the listed compounds.

The present invention can also be applied to the fabrication and analysis of material systems that include particulate glass compounds for a variety of applications. For example, glass microspheres are utilized for a variety of applications. By varying the precursor composition and the reaction conditions, the optimum conditions for the fabrication of hollow particles having a selected wall thickness can be determined. Other glasses, such as sealing glasses utilized in the electronics industry can be fabricated and analyzed for properties such as the softening point and adhesion. Non-reacted glass precursors can also be fabricated and analyzed, such as those used for the fabrication of optical waveguides.

The present invention is also applicable to solder materials, which are multi-component metal alloys having a low melting temperature that are used for joining other metal structures, such as by welding. Solder compositions typically include Pb and Sn along with other elements such as In and Zn. The concentrations of the components can be varied to optimize properties such as melting temperature of the solder alloy, oxidation resistance of the weld, pull-strength of the weld and the like.

In another embodiment of the present invention, the method of the present invention is utilized to fabricate and analyze hard, optically transparent conductors for use in forming transparent conductive electrodes (TCE's). TCE's are utilized in devices such as electroluminescent displays and lamps, solar cells and automotive glass. For example, indium-tin oxide (ITO) is a material that is commonly used as a TCE material wherein the compound includes about 95 to 99.5 weight percent In₂O₃ and about 0.5 to 5 weight percent SnO₂. Other compounds include Zn₂In₂O₅ and other similar compounds containing the In, Sn, Zn, Sb, V, Mg and Ce oxides. The optical transparency and electrical conductivity of these compounds is significantly influenced by the reaction conditions and the ratio of indium to tin within the compound. According to the present invention, these variables can be controllably changed during processing and the deposited material can be analyzed for these properties. For example, the method of the present invention can be utilized to explore the ternary system of In₂O₃, SnO₂ and ZnO. In addition, liquid precursor to one or more of the components, such as In₂O₃, can be included along with optically-transparent particles to enhance the properties of the deposited layer.

The present invention is also applicable to the fabrication and analysis of material systems that include electrocatalysts. One type of electrocatalyst material is a supported electrocatalyst wherein an active species such as a metal or metal oxide is dispersed on a conductive support. Preferred metals for the active species include platinum, palladium, silver, ruthenium, osmium and their alloys. Metal oxide active species can include, for example, manganese oxide (MnOₓ). The performance of the supported electrocatalyst particle can depend upon a number of intrinsic properties such as the concentration of active species and the dispersion of the active species on the support. The nature of the support can also influence the properties of the electrocatalyst particles. For example, the crystallinity of a carbon support or the porosity and pore structure of the carbon support can influence the electrocatalyst properties. The fabrication and analysis of different support materials, such as metal nitrides, metal carbides and metal borides, can also be useful.

In addition, some useful electrocatalyst particles are unsupported particles.

Examples include perovskite phase metal oxides such as La₁₋ₓSrₓFe_{0.6}Co_{0.4}O₃ and La₁₋ₓCaₓ CoO₃. Other useful oxides include oxygen deficient Co-Ni-O and spinels of the form AB₂O₄ where A is selected from divalent metals such as Mg, Ca, Sr, Ba, Fe, Ru, Co, Ni, Cu, Pd, Pt, Eu, Sm, Sn, Zn, Cd, Hg or combinations thereof and B is selected from trivalent metals such as Co, Mn, Re, Al, Ga, In, Fe, Ru, Os, Cr, Mo, W, Y, Sc, lanthanide metals and combinations thereof. Other electrocatalysts can be derived from molecular compounds that are either dispersed on a support phase or are unsupported. Examples include metal porphyrin complexes and other metal ligand complexes.

The present invention is also applicable to the fabrication and analysis of other catalyst materials, including reformer catalysts, hydrodesulfurization catalysts and other catalysts for chemical reactions. For example, reformer catalysts are used to convert hydrocarbons to hydrogen-rich gas mixtures for use as a fuel in fuel cells. Reformer catalysts typically include platinum, palladium, ruthenium or their alloys dispersed on a metal oxide such as alumina or ceria.

Other catalyst compositions can also be synthesized, such as those used in water-gas shift reactions, auto-thermal reforming and steam reforming. Examples of these compositions are listed in Table 1.

TABLE 1
Catalyst Compositions

| Catalyst | Catalytic | | | Target Reaction | Variations in |
|---|---|---|---|---|---|
| Formulations | Reaction | Composition | | Temperature | Synthesis |
| AuNi/γ-alumina | SR/HT WGSR | A) 10 | wt. % Ni | 650° C.-700° C. | Time, temperature |
| AuNi/MgO | Goal: minimize | 0.2 | wt. % Au | | of synthesis to vary |
| AuNi/SiO₂ | coke formation | B) 15 | wt. % Ni, | | dispersion and |
| Reference: | | 0.3 | wt. % Au | | alloy stoichiometry |
| Ni/alumina | | | | | |
| Ru/γ-alumina | SR/HT WGSR | 0.1-0.3 | wt. % Ru | 650° C.-700° C. | Time, temperature |
| | Goal: minimize | | | | of synthesis to vary |
| | coke formation | | | | dispersion |
| Ni/CeO₂/ | ATR | 5-15 | wt. % Ni | 650° C.-750° C. | Time, temperature |
| γ-alumina | Goal: increase | | | | of synthesis to vary |
| | conversion for | | | | dispersion |
| | diesel and | | | | |
| | selectivity for H₂ | | | | |
| NiRu/CeO₂/ | ATR | A) 10 | wt. % Ni | 650° C.-750° C. | Time, temperature |
| γ-alumina | Goal: increase | 0.3 | wt. % Ru | | of synthesis to vary |
| (or other oxide ion | conversion for | B) 15 | wt. % Ni, | | dispersion and |
| conducting | diesel and | 0.5 | wt. % Ru | | alloy stoichiometry |
| support) | selectivity for H₂ | | | | |
| Pt/CeO₂/ | LT WGSR | 0.1-0.3 | wt. % Pt | 200° C.-300° C. | Time, temperature |
| γ-alumina | Goal: <0.5% CO | | | | of synthesis to vary |
| | | | | | dispersion |
| PtRu/CeO₂/ | LT WGSR | 0.1-0.3 | wt. % PtRu | 200° C.-300° C. | Time, temperature |

| | | | |
|---|---|---|---|
| γ-alumina | Goal: <0.5% CO | Pt:Ru = 50:50 | of synthesis to vary |
| | | | dispersion and |
| | | | alloy stoichiometry |

WGSR = water gas shift reaction
ATR = auto-thermal reforming
SR = steam reforming
LT = low temperature
HT = high temperature

Hydrodesulfurization catalysts can also be synthesized in accordance with the present invention. For example, the starting point for development of improved hydrodesulfurization (HDS) catalysts can be based on the catalysts that are currently available. Examples of such materials are listed in Table 2.

One of the innovative approaches according to the present invention is to intimately mix the HDS catalyst with the sulfur removal material. This involves mixing in the sense of a microchannel reactor and using the sulfur removal material (ZnO) as the support phase for the active HDS catalysts. It is feasible to combine these two into a single reactor chamber and into a single multifunctional material, because the temperature at which the NiMoS species catalytically converts mercaptans to H₂S is very similar to the temperature at which ZnO reacts to form H₂S. There is a strong benefit to having these two reactions occur in very close proximity from a diffusional and thermal integration viewpoint.

TABLE 2
Hydrodesulfurization Catalysts

| Catalyst | Catalytic | | | Target Reaction | Variations in |
|---|---|---|---|---|---|
| Formulations | Reaction | Composition | | Temperature | Synthesis |
| NiMo/γ-alumina | HDS | 15.0 | wt. % MoO₃ | 400° C. | Time, temperature |
| | Goal: eliminate | 3.0 | wt. % NiO | | of synthesis to vary |
| | S-containing | | | | dispersion and |
| | aromatics | | | | alloy stoichiometry |
| NiMo high surface | HDS | 85.0 | wt. % MoO₃ | 400° C. | Time, temperature |
| area self- | Goal: eliminate | 15 | wt. % NiO | | of synthesis to vary |
| supporting oxide | S-containing | | | | PSD, porosity, |
| | aromatics | | | | surface area |
| ZnO high surface | HDS/Sulfur | 100% | ZnO | 400° C. | Time, temperature |
| area self- | removal | | | | of synthesis to vary |
| supporting oxide | Goal: <1 ppm S | | | | PSD, porosity, |
| | | | | | surface area |
| NiMo/ZnO | HDS/Sulfur | 3 | wt. % MoO₃, | 400° C. | Time, temperature |
| | removal | 0.6 | wt. NiO | | of synthesis to vary |
| | Goal: <1 ppm S | 96.4 | wt. % ZnO | | PSD, porosity, |
| | | | | | surface area |

The present invention is also applicable to the formation and analysis of materials useful as biological taggants or “quantum dots”. These are small particles (e.g., about 1 to 10 nanometers) that are injected with biological materials such as cells with an attachment compound. The particles preferentially attach to a biological feature of interest (e.g., a cancerous cell) and can then be detected to measure the concentration of such cells. The materials are phosphors (e.g., YF₃) or semiconductors (e.g., Si-In-Ge) that emit light of a known wavelength when suitably stimulated. Changes in the material composition affect the emitted wavelength and also affect the ability of the attachment mechanism to attach to the tag.

The present invention can also be used to fabricate materials systems that include particles that block ultraviolet light but have low catalytic activity. Such particles are useful in sunscreen compositions. For example, the dopant level (e.g., Sb, Sn or V) in an oxide (e.g., TiO₂ or ZnO) can be varied to minimize the catalytic activity of the particles.

The present invention is also applicable to material systems that include polymers including proton conductive polymers that are useful in membrane electrode assemblies (MEA's) for fuel cells. Such polymers can be, for example, hydrophobic or hydrophilic fluorocarbon or fluorosulfonate polymers. By varying the ratio of monomers, initiators and solvents as well as the reaction conditions, the polymer with the most advantageous properties can be selected. The properties of the polymer that can be analyzed include the glass transition temperature as well as the polymer structure. The fluorocarbon polymers utilized in fuel cells, batteries, supercapacitors and similar devices include a polymer chain having a variety of functional groups located on the backbone of the chain. The type of functional group and the spacing and location of the functional group on the chain influences the foregoing properties. As a specific example, proton-conductive polymers such as NAFION in the form of small particles can be mixed with carbon particles and platinum particles in a liquid vehicle and deposited to form a layer. The layer can be analyzed for a variety of properties including the electrocatalytic activity of the layer as well as the ability of a gas to penetrate the layer (expressed as a Gurley number). For example, one or more components of the material systems can be varied to increase or reduce the open porosity of the layered structure, thereby changing the gas diffusion characteristics of the layer.

After deposition and post-treatment, if any, the collected materials and material systems can be analyzed for a variety of material properties. For example, test strips can be probed for conductivity, optical transparency, thermal conductivity, adhesion, hardness, electromigration resistance and the like. A key feature of the present invention is that the material systems can include powders thereby providing direct information about the relationship between chemical composition, microstructure, particle size or other chemical or morphological property and the useful properties of the material.

Examples of analysis devices are disclosed in U.S. Pat. No. 5,776,359 by Schultz et al., which is incorporated herein by reference in its entirety. The analysis device will depend upon the property being measured and the nature of the material. Both intrinsic properties and extrinsic properties can be measured. Examples of intrinsic properties are particle size, morphology, composition, crystallinity and the like. Examples of extrinsic properties include electrical conductivity, electrocatalytic activity, adhesion strength and the like. Analysis devices can include Raman spectroscopy, NMR spectroscopy, microscopy devices, RF susceptibility probes, SQUID detection devices, photodetectors and the like.

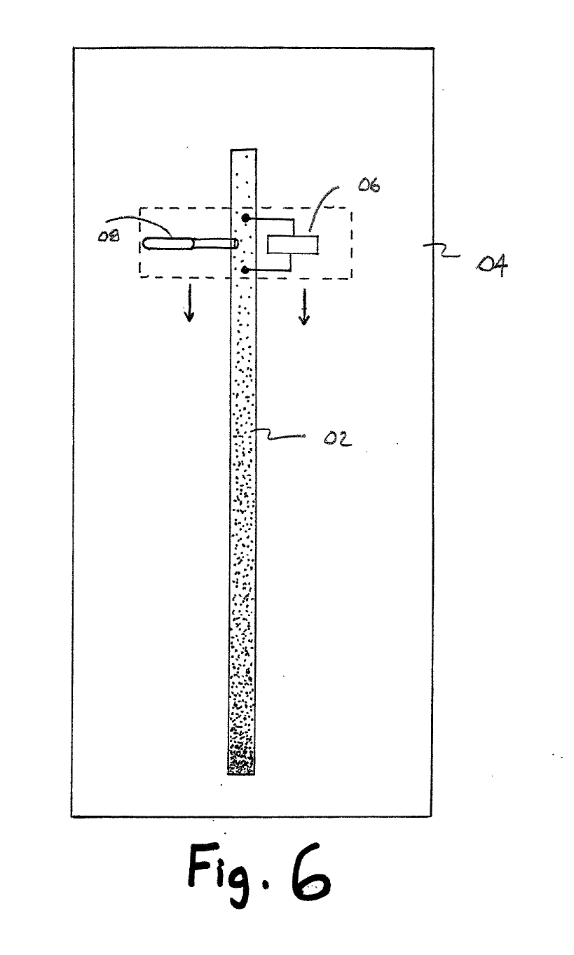

One test probe and method for analyzing the properties of a thick film paste materials system that includes an optically transparent conductor is illustrated in FIG. 6. A linear feature 602 comprising an optically transparent conductor of variable composition is deposited onto a substrate 604 in accordance with the present invention and is heated to remove the volatile constituents. A probe 606 is then used to measure resistivity, after determining the cross-sectional area of the strip 602 by profilometry. Passing a laser beam 608 through the linear feature and measuring attenuation of the beam as a function of position on the feature provides a useful measure optical transmission. In this instance, the substrate 604 is glass or some other light transmitting substrate. The probe 606 and laser beam 608 are moved in a continuous fashion down the length of the test strip 602. The data is collected and analyzed to determine which portion of the test strip 602 has the most advantageous combination of optical and electrical properties for a selected application.

The testing of an MEA structure can be carried out by forming a multilayer structure on a proton conducting membrane. For example, a material system layer including an electrocatalyst, proton conducting polymer, electrically conducting carbon and a hydrophobic polymer can be deposited in contact with a membrane. A gas diffusion layer can then be deposited on this layer which includes a hydrophobic polymer and an electrically conducting carbon. The structure of the anode on the opposite side of the membrane is generally the same. The cathode should be in contact with oxygen and the anode should be in contact with hydrogen and a circuit formed to monitor the flow of electrons. Testing such a structure can generate polarization curves quantifying the performance of the structure.

While various embodiments of the present invention have been described in detail, modifications and adaptations of those embodiments will occur to those skilled in the art. Such modifications and adaptations are within the scope of the present invention.

What is claimed is:

1. A method for the fabrication of a plurality of material systems, comprising the steps of:
a) continuously providing a material system composition comprising at least a first material system component and a second material system component;
b) depositing said material system composition onto a substrate; and
c) analyzing at least one material property of said material system composition, wherein a material property of at least one of said first material system component and said second material system component is varied on a real-time basis such that said material system composition comprises a first material system composition at a first time and a second material system composition at a second time.

2. A method as recited in claim 1, wherein at least one of said first and second material system components comprises a particulate reacted precursor.

3. A method as recited in claim 1, wherein at least one of said first and second material system components comprises a particulate reacted precursor and wherein the composition of said particulate reacted precursor is varied on a real time basis.

4. A method as recited in claim 1, further comprising the step of reacting said material system composition after said depositing step.

5. A method as recited in claim 1, further comprising the step of reacting said material system composition by heating after said depositing step.

6. A method as recited in claim 1, wherein said depositing step comprises depositing said material system composition using a direct-write tool.

7. A method as recited in claim 1, wherein said depositing step comprises depositing a linear feature.

8. A method as recited in claim 1, wherein said material system composition is a thick-film paste.

9. A method as recited in claim 1, wherein said material system is a polymer thick-film paste.

10. A method as recited in claim 1, wherein said material system is an ultra-low fire conductor composition and at least one of said first and second material system components comprises a metal-organic decomposition compound.

11. A method as recited in claim 1, wherein said first material system component comprises an electrocatalyst and said second material system component comprises a polymer.

12. A method as recited in claim 1, wherein said first material system component comprises carbon and said second material system component comprises a polymer.

13. A method for the fabrication of a plurality of material systems, comprising the steps of:
a) continuously providing a material system composition comprising at least a first material system component and a second material system component;
b) depositing said material system composition; and
c) analyzing at least one material property of said material system composition, wherein the relative concentration of at least one of said first material system component and said second material system component is varied on a real-time basis such that said material system composition comprises a first material system composition at a first time and a second material system composition at a second time.

14. A method as recited in claim 13, further comprising the step of mixing said material system composition prior to said deposition step.

15. A method as recited in claim 13, wherein at least one of said first and second material system components comprises a particulate reacted precursor.

16. A method as recited in claim 13, wherein at least one of said first and second material system components comprises a particulate reacted precursor and wherein the composition of said particulate reacted precursor is varied on a real time basis.

17. A method as recited in claim 13, further comprising the step of reacting said material system composition after said depositing step.

18. A method as recited in claim 13, further comprising the step of reacting said material system composition by heating after said depositing step.

19. A method as recited in claim 13, wherein said depositing step comprises depositing said material system composition using a direct-write tool.

20. A method as recited in claim 13, wherein said depositing step comprises depositing a linear feature.

21. A method as recited in claim 13, wherein said material system composition is a thick-film paste.

22. A method as recited in claim 13, wherein said material system composition is a polymer thick-film paste.

23. A method as recited in claim 13, wherein said material system is an ultra-low fire conductor composition and at least one of said first and second material system components comprises a metal-organic decomposition compound.

24. A method as recited in claim 13, wherein said first material system component comprises electrocatalyst particles and wherein said second material system component comprises a polymer.

25. A method as recited in claim 13, wherein said first material system component comprises carbon particles and wherein said second material system component comprises a polymer.

26. A method for the deposition and analysis of a multi-layer structure, comprising the steps of:
a) depositing a first material on a substrate;
b) depositing a second material over said first material to form a multi-layer structure; and
c) analyzing said multi-layer structure for at least one material property, wherein the composition of at least one of said first material and said second material is varied on a real-time basis such that said multi-layer structure comprises a first multi-layer composition at a first time and a second multi-layer composition at a second time.

27. A method as recited in claim 26, wherein said depositing steps comprise depositing said first and second materials as linear features on said substrate.

28. A method as recited in claim 26, wherein said depositing step comprises depositing said first and second materials with a direct-write tool.

29. A method as recited in claim 26, wherein at least one of said first and second materials is a particulate reacted precursor.

30. A method as recited in claim 26, wherein at least one of said first and second materials comprises a polymer.

31. A method as recited in claim 26, wherein at least one of said first and second materials comprises a hydrophobic polymer.

32. A method as recited in claim 26, wherein at least one of said first and second materials comprises an electrocatalyst.

33. A method for the deposition and analysis of a multi-layer structure, comprising the steps of:
a) depositing a first material on a substrate;
b) depositing a second material over said first material to form a multi-layer structure; and
c) analyzing said multi-layer structure for at least one material property, wherein the ratio of said first material to said second material is varied on a real-time basis such that said multi-layer structure comprises a first multi-layer composition at a first time and a second multi-layer composition at a second time.

34. A method as recited in claim 33, wherein said depositing steps comprise depositing said first and second materials as linear features on said substrate.

35. A method as recited in claim 33, wherein said depositing step comprises depositing said first and second materials with a direct-write tool.

36. A method as recited in claim 33, wherein at least one of said first and second materials is a particulate reacted precursor.

37. A method as recited in claim 33, wherein at least one of said first and second materials comprises a polymer.

38. A method as recited in claim 33, wherein at least one of said first and second materials comprises a hydrophobic polymer.

39. A method as recited in claim 33, wherein at least one of said first and second materials comprises an electrocatalyst.
